(19) United States
(12) Patent Application Publication
(10) Pub. No.: US 2016/0225102 A1
(43) Pub. Date: Aug. 4, 2016

(54) LOCATION BASED MEDIA DISTRIBUTION AND CONTENT DELIVERY AND DISCOVERY MECHANISM

(71) Applicant: TuneCore, Inc., Brooklyn, NY (US)

(72) Inventors: James DeNino, Boston, MA (US); Kedar Frederic, Boston, MA (US)

(21) Appl. No.: 15/012,073

(22) Filed: Feb. 1, 2016

Related U.S. Application Data
(60) Provisional application No. 62/110,593, filed on Feb. 1, 2015.

(51) Int. Cl. G06Q 50/00; H04L 29/08

(52) U.S. Cl. CPC G06Q 50/01; H04L 67/18; H04L 67/22

(57) ABSTRACT

A location based media distribution and content delivery and discovery mechanism is provided comprising systems and methods for distributing content in the form of content bundles by creating content bundles and publishing those content bundles. The content bundles are published with publication rules that define a first physical location, and those content bundles may only be accessed by consumers at that first physical location. Consumers may republish content bundles with republication rules defining a second physical location, the second physical location being a location of the consumer at the time of republication.

### CROSS REFERENCE TO RELATED APPLICATIONS

This application claims the benefit of U.S. Provisional Patent Application No. 62/110,593, filed Feb. 1, 2015, the contents of which are incorporated by reference herein in their entirety.

### FIELD OF THE INVENTION

One embodiment of the present disclosure is directed to computer-implemented methods and systems relating to the creating and placing of shareable content or content bundles on a digital map (e.g., coordinates corresponding with a real-world location) and tracking the sharing of the content or content bundles by users of a corresponding mobile application who physically move from location to location.

### BACKGROUND

Content providers, such as musicians, often seek to get exposure for their content and engage their target audience as broadly as possible. This is often done through live interactions, such as concerts, by utilizing traditional content distribution and marketing methods, and by utilizing social media platforms to interact with a fanbase.

Existing tools for interacting with an audience are typically limited to in person interactions and the general broadcast of content. This includes making content available for download or distributing content through social media platforms. While these methods of content distribution make it easy to reach a wide audience, they lack the directed distribution and intimacy associated with real world interactions, such as the handing over of a physical album to a fan. Additionally, without an association with physical space, a long list of available content may make it difficult for a fan to find music and for an artist to distinguish his offering. By targeting a physical location, a musician can distinguish his offering. Further, handing over a physical album to a fan allows that fan to further distribute the album in real space by handing it over to another fan.

Further, traditional content distribution means do not lend themselves to data analysis, since consumers may share content outside of the platform in which they initially retrieved the content. Accordingly, content providers may not be able to monitor the distribution of their content beyond an initial consumer.

Accordingly, the existing methods of interacting with a fanbase do not take into account the location of the fans in the real world, nor do they create any interaction between the real world and the distribution of content. Further, they do not create any way for consumers of content to further interact with physical space. Similarly, existing platforms do not take into account the location of the musician distributing content or the location.

There is a need for a digital platform that maintains the wide distribution of social networks while incorporating the intimacy associated with content discovery and acquisition in physical space. There is a further need to allow consumers to interact with their environment directly to further distribute digital content. Finally, there is a need for a platform that allows for analytics monitoring consumer use of the distribution platform.

### SUMMARY

The present invention comprises a mechanism for entertainment or content creators/providers including, but not limited to, musicians, comedians, brands, etc., to create digital bundles of audio, video, images, and other content that can be created and/or imported from third-party social media websites. A digital content bundle can be initially placed on a digital map (e.g., as an interactive graphic icon) at a location. The placement of the digital content bundle may be in order to associate the content with something in the physical world. For example, a musician may locate a content bundle near a poster advertising an upcoming concert, or a musician may choose to distribute content at a concert.

A user that has a mobile device can use a corresponding application on the device to see which content bundles are near to their current location (e.g., within a 1-mile radius of the user's physical location). The user can then physically go to a content bundle location in the real world, use the application to pick up (i.e., save it to their application) the content bundle at that location and drop it (i.e., copy it) to a different location where the user physically goes at a later time. In one implementation, the user must be at or near the corresponding physical location in the real world in order to pick up or drop a content bundle at that location. The process can be repeated any number of times and content bundles can be copied by individual users to any other location.

Further, the system can track the path of content bundles as they are copied to different locations, and can also track how a user interacts with the content in each bundle. This gives the provider of the content bundle insight into how the content is shared in terms of physical location as well as what content is interesting to users.

Accordingly, a location based media distribution and content delivery and discovery mechanism is provided comprising systems and methods for distributing content in the form of content bundles by creating content bundles and publishing those content bundles. The content bundles are published with publication rules that define a first physical location, and those content bundles may only be accessed by consumers at that first physical location. Consumers may republish content bundles with republication rules defining a second physical location, the second physical location being a location of the consumer at the time of republication.

The method may allow for a notification, distributed by social media platforms, that a content bundle has been published or republished. Further, the method may provide metrics regarding various content bundles distributed within the system.

### BRIEF DESCRIPTION OF THE DRAWINGS

FIG. 1 shows an exemplary system for implementing a method for distributing media.

FIG. 2 is a flowchart of a method for distributing media of the present disclosure.

FIG. 3 is a diagram showing one embodiment of an overview of the provider account creation process of the present disclosure.

FIG. 4 is a diagram showing one embodiment of an overview of the provider profile population process of the present disclosure.

FIG. 5 is a diagram showing one embodiment of an overview of the provider content bundle population process of the present disclosure.

FIG. 6 is a diagram showing one embodiment of an overview of the provider content bundle publication process of the present disclosure.

FIG. 7 is a diagram showing one embodiment of an overview of the provider metrics dashboard process of the present disclosure.

FIG. 8 is a diagram showing one embodiment of an overview of the consumer account creation process of the present disclosure.

FIG. 9 is a diagram showing one embodiment of an overview of the consumer content discovery and consumption process of the present disclosure.

FIG. 10 is a diagram showing one embodiment of an overview of the consumer content bundle republication process of the present disclosure.

FIG. 11 is a diagram showing an overview of one embodiment of the system architecture of the present disclosure.

### DETAILED DESCRIPTION OF THE PREFERRED EMBODIMENTS

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features.

This disclosure describes the best mode or modes of practicing the invention as presently contemplated. This description is not intended to be understood in a limiting sense, but provides an example of the invention presented solely for illustrative purposes by reference to the accompanying drawings to advise one of ordinary skill in the art of the advantages and construction of the invention. In the various views of the drawings, like reference characters designate like or similar parts.

Described below are various methods and systems for distributing media, particularly by use of a location based content delivery and discovery platform. Media distributed by this platform is grouped into a content bundle, which may comprise several files of various types of digital content, such as digital audio files, videos, images, and text. Once a content bundle is formed by a content provider, it is distributed to content consumers using the platform described.

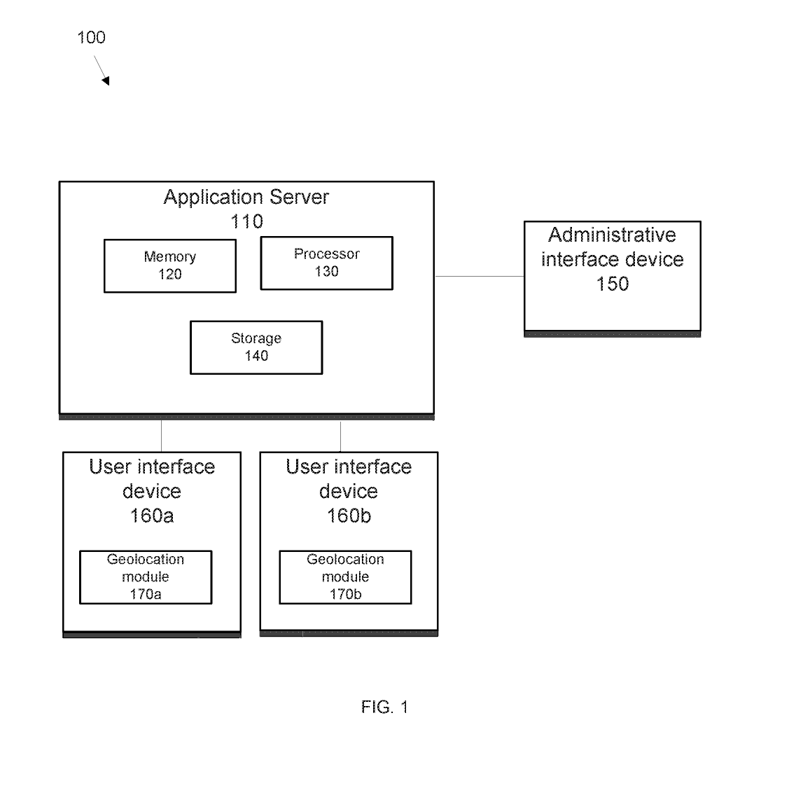

FIG. 1 shows an exemplary system 100 for implementing such a platform and utilizing the methods described. Typically, an application server 110 is provided in communication with a computerized network, the application server having a memory 120 for storing a software application and a processor 130 for implementing the software application. Typically, a storage 140 is provided for storing media files uploaded to the system for distribution to consumers. Such a storage may be a hard drive or set of hard drives on the application server 110, or it may be a separate server connected to the application server 110 using a network.

The system 100 further comprises an administrative interface device 150 which may be used to access the application server 110 and create content bundles for distribution to consumers, as well as a plurality of user interface devices 160a, b, that may be used to access and retrieve content bundles. Each user interface device 160a, b is equipped with a geolocation module 170a, b, such as a GPS unit, which can be used to determine the physical location of the corresponding user interface device. The various interface devices may be, for example, portable computing devices, such as smart phones, tablets, laptops, or other types of computer terminals. In some embodiments, while the user interface devices 160 must be portable and must include a geolocation module 170, the administrative interface device 150 may not be portable and may be, for example, a desktop computer.

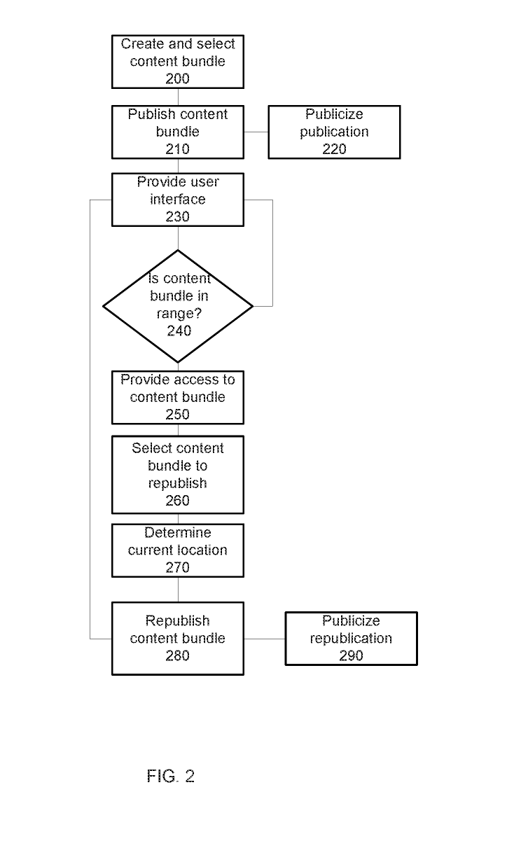

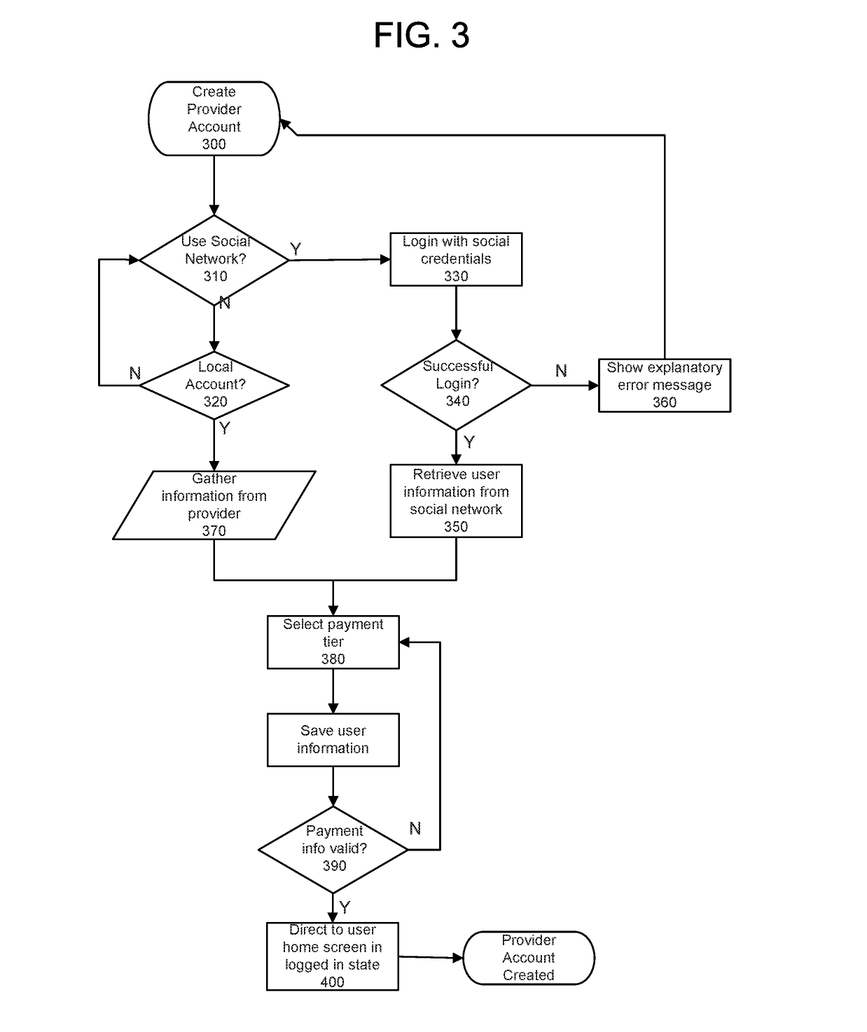

FIG. 2 is a flowchart illustrating an implementation of the method for distributing media. FIGS. 3-10 provide additional details for certain aspects of the method.

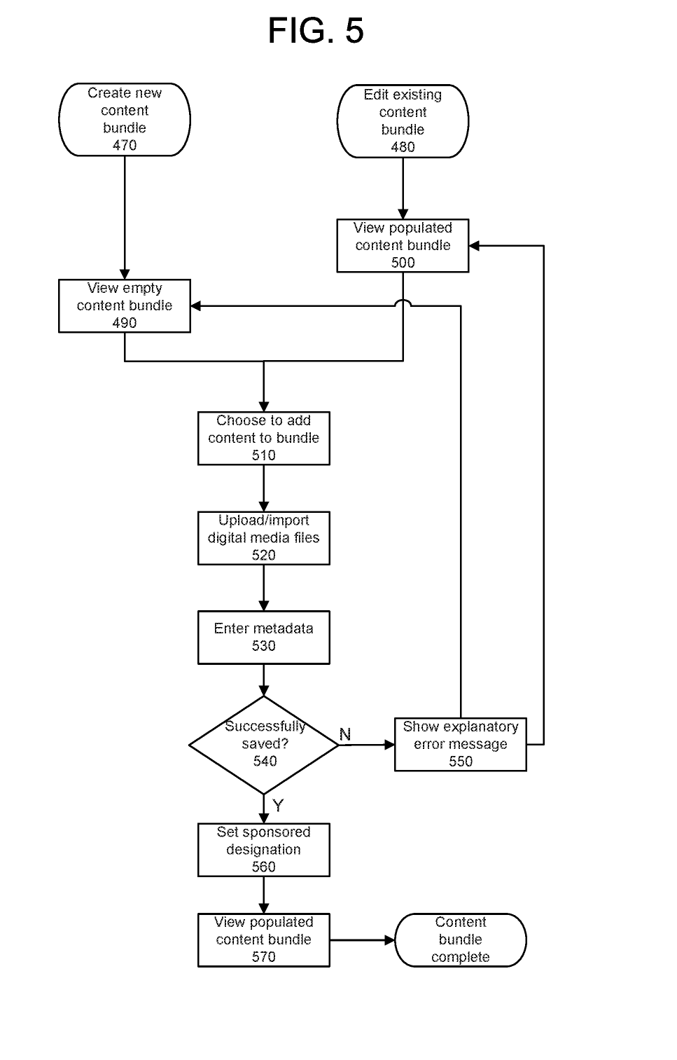

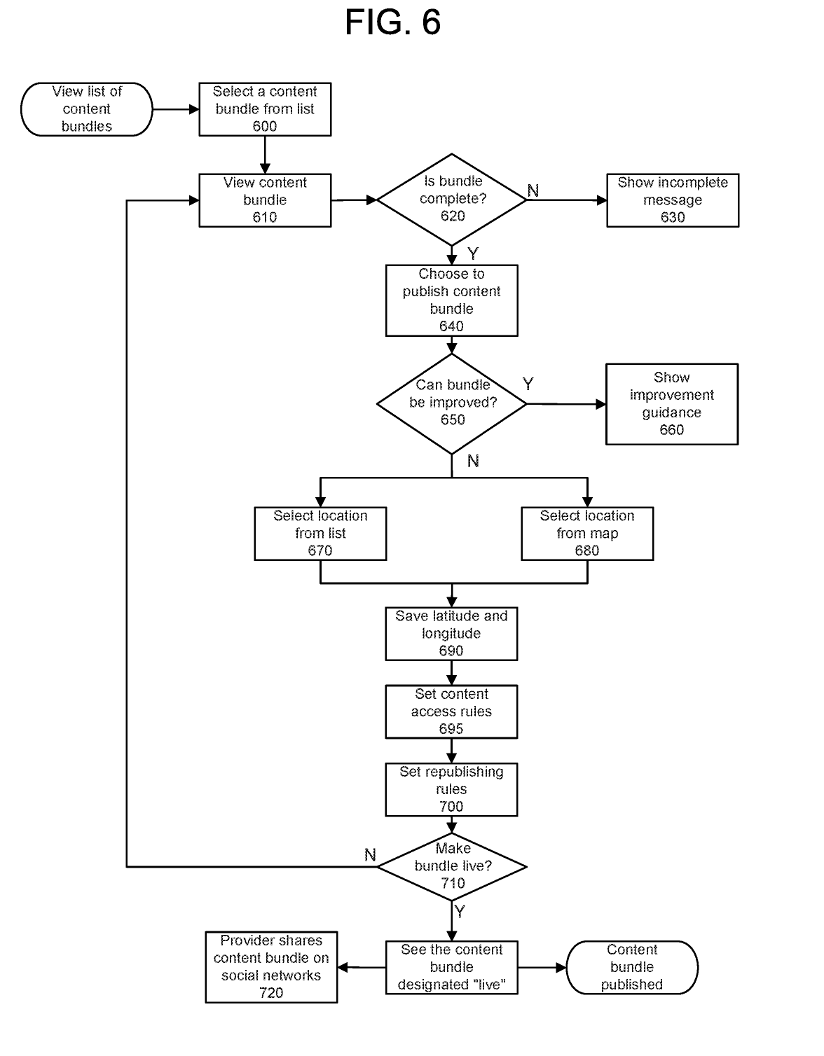

Initially, a user with administrative rights creates and selects content bundles to distribute (200). This user may be a content provider, and the bundle may be a collection of content that the provider would like to distribute to users. For example, the content bundle may be several media files including music, video, and images related to a new music album. Alternatively, the content bundle may be coupons and advertisements for a particular product or service distributed by a vendor. The creation and population of such content bundles is explained in more detail below in reference to FIG. 5, and the selection of such a bundle is explained in more detail below in reference to FIG. 6.

The user with administrative rights may then publish the content bundle (210), along with a set of associated publication rules. Such publication rules define a first physical location at which the bundle is to be virtually located, and indicate that the content bundle may only be accessed if a consumer is within range of the first physical location. Typically, upon publication, or prior to publication, the contents of the content bundle are placed in storage 140 so that they may be retrieved by content consumers utilizing the platform. In some embodiments, publication of the content bundle (210) applies publication rules to the bundle and makes it available and a content provider publishing content may publicize the publication (220) through, for example, posting of details of the publication on social networks. The publication of content bundles is explained in more detail below in reference to FIG. 6.

Users of the system 100 may be content consumers who wish to view the contents of such bundles. Typically, such consumers access the system through user interface devices 160, such as smartphones. Such a user would be provided with a user interface (230) with which to search for and access content bundles. When a first consumer wishes to access a particular content bundle, he may select the content bundle from a list of available content bundles.

Because the publication rules dictate that consumers may only access the content bundle if they are within range of the first physical location, the application server 110 then determines, using the geolocation module 170a of the first consumer's user interface device 160a, if the first consumer is at, or within range of, the first physical location (240). If so, the user is provided with access to the content bundle (250). Such access may be provided within the user interface in the form of an option to download the files of content bundle from the storage 140. Alternatively, such access may be provided in the form of access to media in the content bundle through the application, while the application provides a media player in which to view the content. Accordingly, media from the content bundle may be accessed at the user interface device 160a while the actual digital files remain in storage 140.

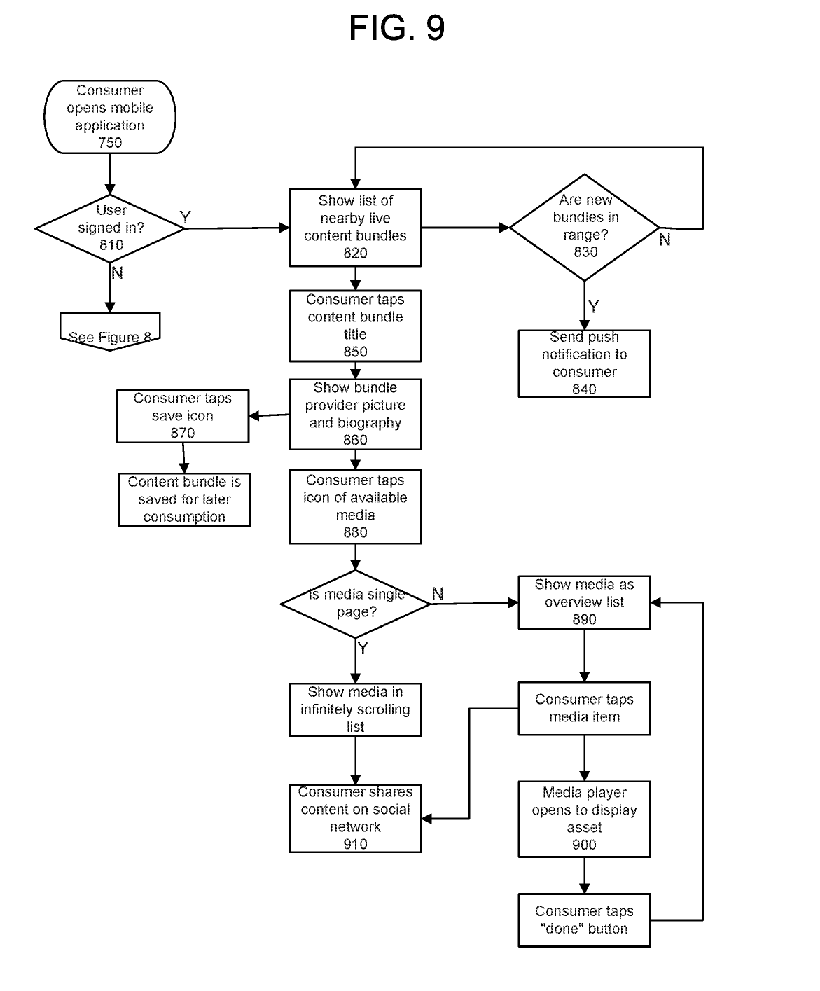

In some embodiments, the user interface provided (at 230) may provide a listing of nearby content bundles that can be accessed, or may illustrate the location of nearby content bundles in a map interface. The discovery and consumption of content bundles is described in more detail below in reference to FIG. 9.

In some embodiments, a first consumer that has been provided with access to the content bundle (at 250) may choose to republish the content bundle. In such an embodiment, the first consumer may then select a content bundle to republish (260) and instruct the application server 110, through the user interface, to republish the bundle. The application server 110 then determines, using the geolocation module 170a of the user interface device 160a of the first consumer, a physical location of the first consumer at the time of republication (270). The application server then republishes the content bundle (280), making it available to other consumers, along with a set of associated republication rules. Such republication rules define a second physical location at which the bundle is to be virtually located. In the embodiment described, the second physical location is based on the physical location of the first consumer at the time of publication. Accordingly, when a first consumer chooses to republish a content bundle (at 280), the publication is associated with that first consumers location at the time, as if the consumer were physically dropping an object.

Republishing the content bundle (280) may involve uploading content to the storage 140 where content has been downloaded by the first consumer. Alternatively, republishing may relate to a content bundle already stored in the storage 140, and merely applies republication rules to the content bundle, thereby making the existing content bundle available at the second physical location. In some embodiments, the republished content bundle continues to be available at the first physical location. In such an embodiment, both locations may be linked to a single content bundle which may be separately associated with publication rules, assigned at 210, and republication rules, assigned at 280, and which may be accessed by consumers at either the first physical location or the second physical location.

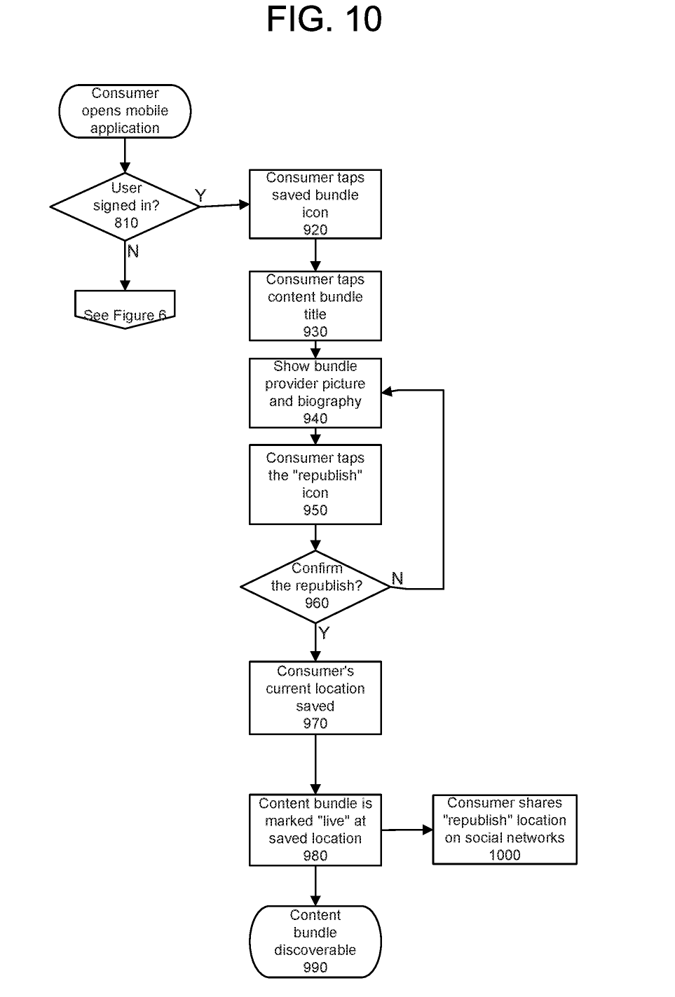

A first consumer republishing content may publicize the republication through, for example, posting of details of the republication on social networks. The republication of content bundles is explained in more detail below in reference to FIG. 10.

The platform may then provide a user interface (230) to a second consumer at a user interface device 160b. The user interface may be used by the second consumer to search for and access content bundles just as the first consumer did. However, the second user may select either an original publication or a republished content bundle. After the second user selects a content bundle, the application server 110 then determines, using the geolocation module 170b of the second consumer's user interface device 160b, if the second consumer is at, or within range of, the second physical location (240) of the republication rules of the content bundle. If so, the user is provided with access to the content bundle.

In some embodiments, rules may be applied during the creation of the content bundle in order to determine how many times a content bundle may be accessed or republished. For example, a publisher may provide that a content bundle can be republished multiple times, such that the second consumer may republish the content bundle at a third location, and such that the content bundle may then be accessed by a third consumer. Additional details related to content access rules are provided below with respect to FIG. 6.

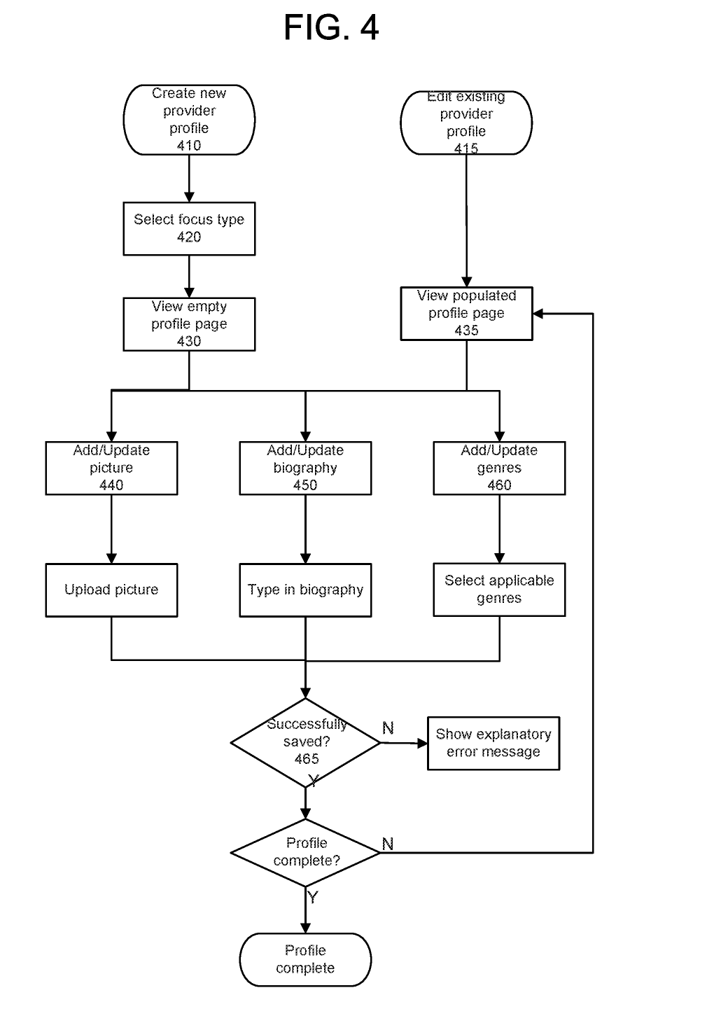

FIGS. 3 and 4 illustrate one embodiment of an overview of the provider account creation and provider profile population process in accordance with one embodiment of a system of the present disclosure. Prior to populating the system with content or content bundles that will be made available, the content provider must create an account (300) and profile that will preferably be used by both the system of the present disclosure and the public desiring to gain access to such content. The provider may do this by accessing the application server 110 using a provider interface device 150.

Typically, in creating such an account, the provider may choose to use an existing account linked to a social network (310) or, in the alternative, create a local account (320) within the system. If the provider chooses to utilize an existing social network account, he must then log in using his social network credentials (330). If the login is successful (340), the application server 110 retrieves the providers user information from the social network directly (350). If the login is unsuccessful, the system provides an explanatory error message (360) and allows the provider to try again. If the provider chooses to create a local account, the platform collects data directly from the provider (370).

The system of the present disclosure offers several tiers of service with various product features available or not available based on a service tier selected (380) by the content provider. Product features available based on tier will encompass types of content that can be included in a content bundle, control over the rules surrounding the consumption of the content bundle, metrics provided to the content provider based on consumption, and so on. After a content provider selects a payment tier (380) and provides valid payment information (390), the provider is directed to his user home screen (400) and the provider account creation process is complete.

FIG. 4 is a diagram showing one embodiment of an overview of the provider profile population process of the present disclosure. Initially, providers begin populating the profile 410 by selecting a focus type (420). Although the system is described with respect to content bundles for music distribution, it will be understood that the platform described is not limited to usage by any particular industry, art, or craft. Accordingly, the content provider is asked to select an area of focus for their particular use case (at 420). Non-limiting examples of focus types include “Digital Music,” “Book Publishing,” “Film & Video,” “Poetry,” and the like. The ability of a content provider to select a focus type enables the system of the present disclosure to tailor genres choices and other media-specific data points related to the content provider, the content or content bundles, and in some embodiments, the engagement of the content providers with consumers of the content or content bundles.

After selecting a focus type (at 420), the provider is presented with an empty profile page (430) as well as options to add or update a picture (440), biography (450), and/or genres (460) associated with the types of content bundles the content provider expects to provide.

In some embodiments, the profile picture of the content provider, provided at 440, functions as the “cover art” for all of the content and content bundles created by the content provider. The profile picture may then be presented in list and map views within a user interface associated with the system to illustrate available content bundles. The profile picture may further function as the primary base image for all content bundles created by the content provider. In some embodiments, this image will be visible in the default content bundle view.

The biography 450 may be the primary textual component of the content bundle. This textual component can contain, but may not be limited to, any Unicode text but is intended to function as the primary base description for all content bundles created by the particular provider. This text will be visible on the default content bundle view.

In one embodiment the genre choices 460 will be taken from precompiled lists that are pertinent to the type of content bundles the provider intends to create. These genre classifications may be used in recommendation compilations made by the product, in allowing the consumer to opt in or out of specific genre classifications, and in other uses. For example, the platform may recommend venues for publication of content bundles based on the genre an artist selects for the content bundle. As such, the platform may have preset recommended locations for particular genres or it may develop, such as based on data collected, an understanding of popular locations for particular genres.

Typically, a user may create a new provide profile (at 410) or may edit their existing provider profile (415). Where an existing profile is being edited, such as after saving initial edits to a profile (465), the provider is presented with its populated profile page (435) and is given opportunities to edit existing content.

FIG. 5 is a diagram showing one embodiment of an overview of the provider content bundle population process of the present disclosure. In such a platform, a provider may either create a new content bundle (470) or edit an existing content bundle (480). Accordingly, the provider may view the new empty content bundle (490) or view the current contents of the existing content bundle (500) and choose to add content (510) or otherwise modify the content bundle. Content may be added by uploading or importing digital media files (520) and entering corresponding metadata (530), such as identifying data for the files added or for the content bundle itself. The provider may then save the content bundle (540) or view an error message explaining why the content bundle cannot be saved (550).

In some embodiments, the system of the present disclosure allows providers at a particular service tier to designate (560) a content bundle as being sponsored. Content bundles designated as sponsored are preferably treated specially by the system such that they are featured prominently in various ways throughout a corresponding consumer application. After finalizing the content bundle in this way, the content bundle is made visible to the provider as a whole (570) so that the provider can see the entire contents of the content bundle as it will be presented to the consumer once it has been published.

FIG. 6 is a diagram showing one embodiment of an overview of the provider content bundle publication process of the present disclosure. A provider first selects a content bundle from a list of created content bundles (600) and views the selected content bundle (610). The platform may then determine whether the content bundle is complete (620). In one embodiment, through various heuristics, the system maintains an understanding of what is required for a content bundle to be considered complete and ready for consumption, and if the content bundle is not complete, a message is provided indicating a reason that it was not deemed complete (630). The area of focus for the provider may be one factor used to select the rules to be applied for this evaluation. Once the provider chooses to publish the selected bundle (640), the system may evaluate whether the bundle can be improved (650). Similar to the heuristics used to determine the completion status of a content bundle, one embodiment of the system offers guidance to the content provider on methods to improve the quality of the content being offered (660) with the purpose of improving consumer engagement and overall reach of the content.

After a provider chooses to proceed with the selected content bundle, the content provider may be offered a compiled list of venues that the system believes are optimal publication locations for the content bundle (670). The content provider may then select a location from the list of compiled recommendations or from other locations as the case may be. This recommendation may be based on the particular artist and statistics related to how previous content bundles have been received, or it may be based on broader data sets related to, for example, the genre the artist uses to classify the particular content bundle.

Accordingly, the content bundle may then be published to one or more of these locations or other locations as selected by the content provider. Alternatively, in one embodiment the content provider may be provided with an interactive map from which he can choose freely from any geographical location available by selecting that location (680). After selecting a location, the system saves a latitude and longitude associated with that location (690), which is incorporated into a set of publication rules for the content bundle. Where the location is selected from a list (at 670), such coordinates are already associated with the location selected. Where the location is chosen on a map (at 680), the longitude and latitude for that location are extracted from the system's map location manager system.

After a location is selected, a content provider may set content access rules (695) in order to exercise control over how consumers will be able to interact with the content once published. This control encompasses, but is not limited to, restricting the total number of times a content bundle can be accessed in total, restricting the size of the geographic area over which the content can be browsed and saved by consumers, limiting the number of plays of a media asset, and so on. Additionally, the content provider may set republishing rules (700). An important factor of one embodiment of the present system and an important aspect of the content consumer experience is the ability to republish a content bundle at a geographic location other than the one or more locations selected by the content provider. In order to allow the content provider control over the dissemination of its content, the system allows the content provider to set rules for republishing. The rules may include, but are not limited to, the restriction of the number of total republications of a content bundle that can be undertaken by any one consumer or by all consumers in aggregate, the geographic location in which the content bundle can or cannot be republished, and so on.

Finally, the content provider can make the content bundle live (710). In some embodiments, the content provider may then publicize the publication of the content bundle by sharing the publication on social networks (720).

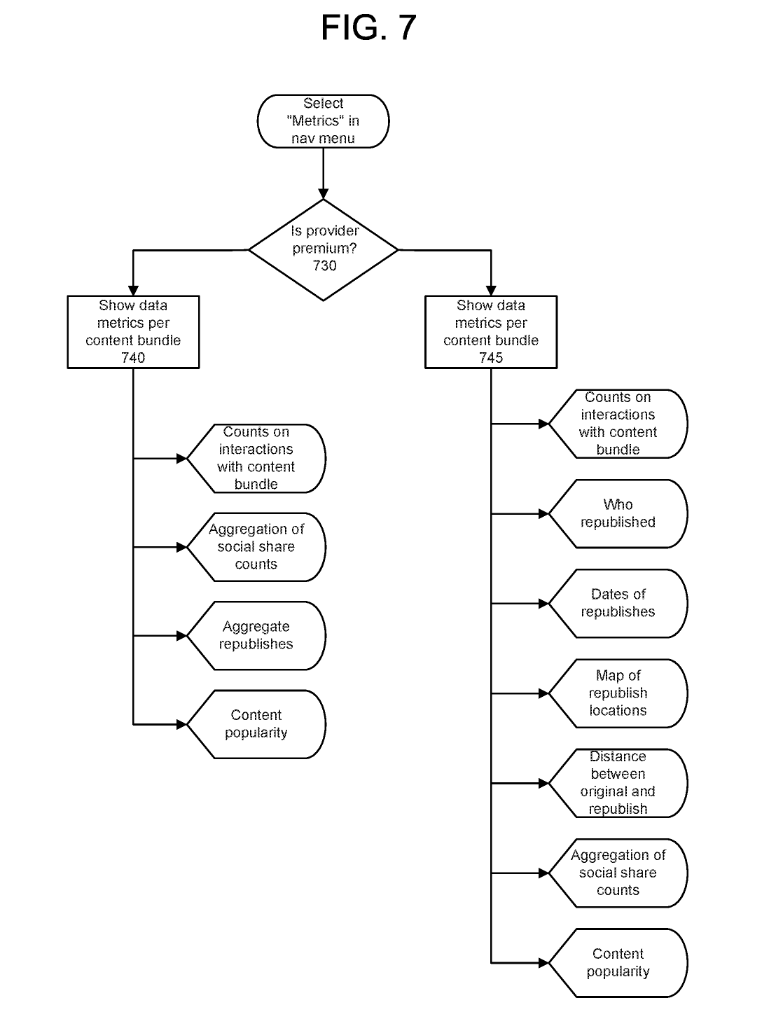

FIG. 7 is a diagram showing one embodiment of an overview of a set of metrics available to content providers through a metrics dashboard. As noted above, the metrics available to a particular content provider may differ depending on whether they are paying for “premium” service (730) or some other service tier. Accordingly, a non-premium content provider may be provided (740) with access to data that is generally aggregated and more general in nature, such as, for example, numbers of republishes and content popularity (reads, listens, etc.) will be offered in aggregate presentations in a variety of visual formats. This may include aggregated data related to general interactions of consumers with a content bundle, aggregations of social media shares associated with a content bundle, and aggregated republications and other measures of content popularity.

For example, a platform implementing the metrics dashboard may evaluate the popularity of a particular content bundle by tracking when users of a corresponding mobile application view or listen to each individual content item within a content bundle and displaying this engagement data to the creator of the content bundle. In this way, the creator of a content bundle may understand what content has been interacted with the most. The platform may take into account actions that have been taken immediately before, during, or after engaging with individual content items as well. For example, when a user listens to a song within a content bundle and then immediately saves the content bundle, the platform will consider that as a reflection on content popularity. The platform may further compare the engagement data across individual content items within content bundles, as well as across content bundles, and may display comparisons to the content bundle creators in order to provide them with data reflecting which content, or types of content, generates the highest levels of engagement.

Where a content provider utilizes a higher service tier, the data may be provided more granularly (745) such as, but not limited to, republications by city or neighborhood, republication velocity, overall virality calculations, content popularity data by city, and so on. Further, the data may be provided in different formats for different service tiers. In some embodiments, a lower tier content provider may only be able to access certain data visualizations, while a higher tier content provider may be provided raw data, which can be analyzed in various ways, such as through a separate API.

Through this dashboard, a wide variety of data may be provided. For example, data may be provided related to the tracking of how often content bundles were downloaded by consumers to whom they were made available, and how often such content bundles were republished. Further, the data may provide comparisons indicating how often identical content bundles were downloaded when they had different publication rules, such as different physical locations. The platform may also be able to rank content bundles using each of these metrics.

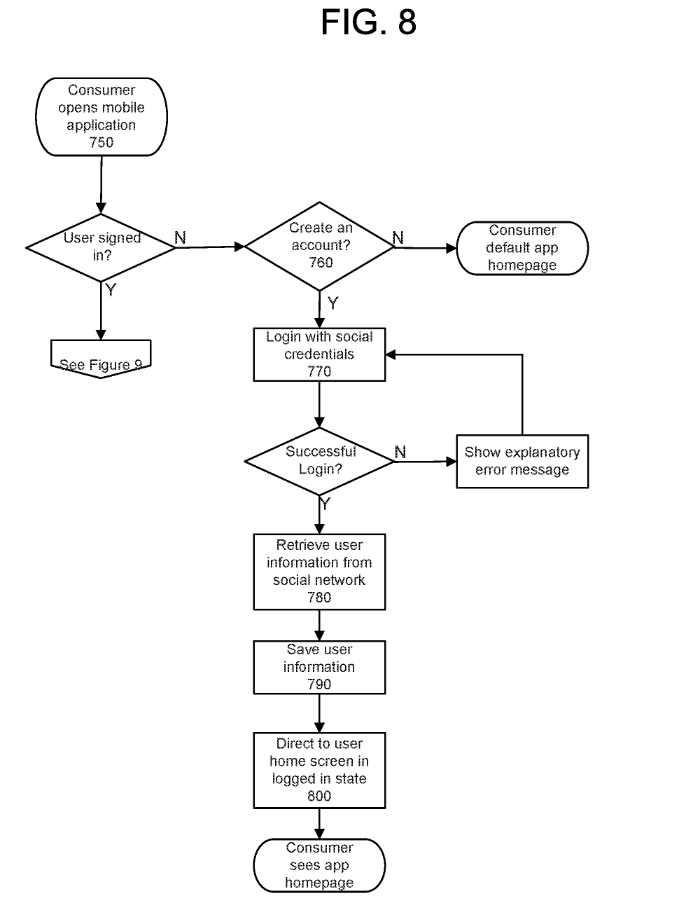

FIG. 8 is a diagram showing one embodiment of an overview of the consumer account creation process of the present disclosure. When a user opens an application associated with the system (750) he can sign in using an existing account. If no such account exists, the user can create one (760). To do so, a user may log in with existing credential from a different social network (770). If such a login is successful, the application retrieves user information from the social network (780) and saves the user information (790) to the user's newly created profile and directs the user to a home screen of the application (800) in a logged in state.

FIG. 9 is a diagram showing one embodiment of an overview of the consumer content discovery and consumption process of the present disclosure. Once a consumer is signed in to the platform (810), he may be presented with a listing of nearby live, or accessible, content bundles (820). In one embodiment, content consumers can discover content bundles by going to a geographical location at which the content or content bundle was published by the content provider. In one embodiment, the consumer will see nearby available content or content bundles on the home screen of the mobile application. Any content bundles available to be browsed may be highlighted or otherwise may be associated with certain indications relating to content disclosure, content availability, and the like. In the event there are sponsored content bundles nearby, they will also be presented in the mobile application.

Typically, the application for the system is utilized as a mobile application through a mobile device, although a non-mobile application may be used. Accordingly, as the content consumer changes geographic location, and if the application is configured to accept notifications, the application will determine if new content bundles are now in range (830). Additionally, where enabled, content consumer will receive push notifications from the system as new live content bundles become available nearby (840).

In some embodiments, this process continues as long as the mobile application is running. In other embodiments, a content consumer may take advantage of the system of the present disclosure on an application that is not necessarily mobile in the sense of a handheld or tablet-based structure, but that may be operable on a traditional computer.

The content consumer will be presented with a list of nearby available content bundles (at 820) and by tapping on the bundle (850) the consumer will be taken to a view showing specific content assets. In one embodiment the content bundle homepage will consist of the profile information (860) supplied by the content provider during account profile setup (see, for example, FIG. 4), which functions as the entry point to the content bundle. The consumer may then choose to save the content bundle (870) for consumption when out of range of the content bundle, in order to associate the content bundle with the content consumer. If the consumer saves the content bundle (870), he can come back to the content bundle at a later time in a different geographic location. In one embodiment, the ability to save a content bundle is contingent on the content asset rules set by the content provider (see, for example, FIG. 6).

If the consumer wishes to consume the media, he can tap an icon representing the media (880). The media then may be presented as a list of available media (890) which the consumer can either display using a media player (900) or share across social networks (910).

FIG. 10 is a diagram showing the consumer content bundle republication process of the present disclosure. Once a user signs in to the platform (810), he can tap an icon for a content bundle (920) that was previously saved (at 870). He can then enter the content bundle by tapping the content bundle title (930) and the user interface shows the bundle provider picture and biography (940). In one embodiment the republishing of content bundles is carried out by the content consumer subject to the rules set forth by the content provider (see, for example, FIG. 4). Tapping the republish icon (950) and confirming the republish (960) will alert the system that the content bundle should be published with its latitude and longitude set to the content consumer's current location, which is saved (970) and associated with the content bundle (980), which is marked as “live” at that location. Other methods of republishing content and notifying the content provider are contemplated. The republished content bundle is subject to the same republish and content access rules as the original content bundle. In one embodiment, the live republished content bundle is now available for other users of the mobile application to discover (990) and potentially save and republish (see, for example, FIG. 9). Additionally, the consumer, after republishing the content, may post the location of the republication on social networks (1000).

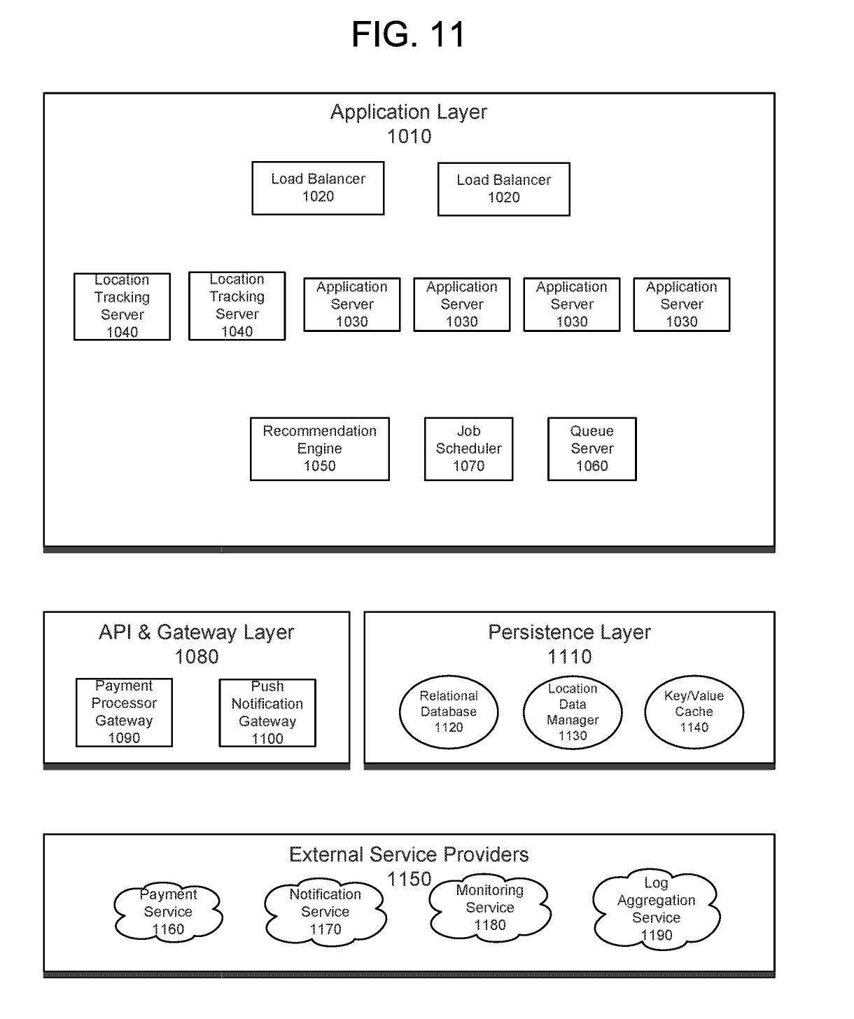

FIG. 11 is a diagram showing one embodiment of an overview of the system architecture of the present disclosure. The application layer 1010 is the topmost functional layer and revolves around the application itself. As shown, the application layer 1010 of the system may comprise a plurality of load balancers 1020 for managing traffic across several application servers 1030. The application servers 1030 are the core stack running the software that maintains user content bundles and their relationships to users of the system. This includes security subsystems used to authenticate and authorize users in the system. The system may further comprise multiple location tracking servers 1040 for monitoring the location of content bundles that have been placed by users. The location tracking servers 1040 relate content bundles to geographic locations based on GPS coordinates and relates those bundles to content within those bundles. The system may include a recommendation engine 1050 for recommending enhancements to content bundles or content bundle publication strategies. Typically, a more complete content bundle may be better received. Accordingly, if a content bundle contains only minimal content, such as a single photo, video, or song, the platform may recommend incorporating additional content to make the content more appealing. The various components are accessed by consumers using a queue server 1060 and actions are coordinated by a job scheduler 1070, which are utilities for handling asynchronous messaging, and to determine whether a content bundle should be made available respectively.

The system may further comprise an API and gateway layer 1080, which are used to interact with services external to the system itself. A payment processor gateway 1090 keeps track of user payment methods and subscription status, including renewal and cancellation dates, and a push notification gateway 1100 interfaces with a geographically-based third party service to alert users when they have traveled into range of one or more available content bundles. Further, the system has a persistence layer 1110 which contains all databases and other data stores that service users of the platform. A relational database 1120 is provided to manage and maintain user account data and content bundle data. A location data manager 1130 is provided to persist the metadata around the location of a content bundle, including longitude, latitude, and venue-specific information. A key/value cache 1140 is a datastore for maintaining shared data and simple data not directly related to a user account or a content bundle.

The system further interacts with several external service providers 1150, typically cloud based services. The system may use a payment service 1160 to process credit cards and other payment methods. The system may further use a notification service 1170 to allow the creation of geographically specific geo-fencing that allows the tracking of a mobile device as it moves into range of an active content bundle. A monitoring service (1180) and log aggregation service (1190) may allow the system to monitor use of the system and performance of the overall system.

In one embodiment, the system of the present disclosures allows opportunities for content creators and retailers, brick and mortar businesses, etc. to develop partnerships referred to as Content Hubs. In such embodiments, content providers may generate exclusive content included within their content bundle and may distribute those content bundles to the respective physical locations of the brick and mortar-based partner. Consumers using the mobile application would then physically go to the location of the content bundle in order to “discover” the content bundle. In one embodiment, the same technology, processes, and controls are applied to the individual use case of each client, allowing them to leverage the platform for their marketing plan. Additional account creation and access may be provided to the Content Hub for the purpose of review and metrics.

In one embodiment, as content providers continue to engage with the system, the system continues to gather information relevant to each particular content provider account. Based on the information collected from this core system, additional products and services may be offered to particular content providers. For example, recommended published content bundle locations will be offered to content providers who opt in to certain pricing tiers. This service will provide recommended locations for content providers to distribute content in order to reach their optimal, or typical, demographic, as well as based on previous successful content bundles for artists the platform considers comparable.

In one embodiment, automatic publication of content bundles may be provided to content providers who opt in to a certain price tier. The system would then allow content providers to populate content bundles in advance, and create a publishing schedule, which will be managed by the system, in order to publish the respective content bundle at the time and location designated by the content provider. In one embodiment, a combination of automatic publishing of content bundles and recommended published content bundle locations is offered to content providers who opt in to a certain price tier.

In one embodiment, as consumers of the mobile application complete the process of discovering and consuming content, and further, complete the action of content bundle republication, individual consumer accounts will be notified when their republications have been consumed by other consumers of the mobile application. This experience will provide consumers of the mobile application with an understanding and presentation of how their republications have benefitted the content provider of the original content bundle.

In one embodiment, a social media and web-based widget is provided to content providers who opt in to certain pricing tiers. The widget may include the content bundle created in the content providers account, and may leverage the same system described above. Content providers would be capable of posting the widget on their desired web page, where consumers of the mobile application would be able to submit their current location, in the form of a street address or other location type, which will them prompt the content bundle to be published to that particular address or location for discovery and consumption of the content bundle.

In one embodiment, a service may be provided to brick and mortar businesses that are classified as small businesses. These businesses would be able to offer their customers exclusive and promotional songs, videos, photos and other pertinent content as a service through the platform. This would enable them to search by music genre or entertainment classification (sports, music, movies, etc.) and choose promotional content for distribution at a fee, to supply for free to consumers who enter their establishment. In one embodiment, this content is curated and pre-negotiated by the company with specific distribution and publishing fees attached. Content may be accessed through an online portal and distributed by providing location, payment, and specifying length of promotion. Content bundles may be custom branded as part of this service and discovered by consumers or fans through the mobile application. In some embodiments, content owners or providers may exercise some control over what establishments can distribute their content.

In one embodiment, brick and mortar businesses, agencies, concert and event promoters, and business establishments of any kind can subscribe to a service in order to have “behind the scenes” or exclusive content placed at their locations during live events such as concerts, award shows, sporting events, live television shows and other live events in the entertainment space. This will create an opportunity to push to consumers and fans content not yet published by public media or in some instances content that won't be published elsewhere. In one embodiment, content will be pushed through the system and accessible through a portal for customers to redistribute for discovery through the mobile application.

In one embodiment, through an API, it will be possible to create other software, mobile applications, and web applications to create custom experiences and allow custom content bundles to be dropped by consumers of all kinds through their own application. For example a sports team may integrate with one embodiment of the system of the present disclosure in order to drop content directly at its stadiums for discovery through its own application. Companies will have the ability to build on top of an API to push content bundles at their discretion for discovery through their primary mobile application. Use of this API will call for transparent data exchange and potential fee after a certain amount of API calls.

The block diagrams in the different depicted embodiments illustrate the architecture, functionality, and operation of some possible implementations of apparatus, methods and computer program products. In this regard, each block in the flowchart or block diagrams may represent a module, segment, or portion of code, which comprises one or more executable instructions for implementing the specified function or functions. In some alternative implementations, the function or functions noted in the block may occur out of the order noted in the figures. For example, in some cases, two blocks shown in succession may be executed substantially concurrently, or the blocks may sometimes be executed in the reverse order, depending upon the functionality involved.

One embodiment of the present disclosure can take the form of an entirely hardware embodiment, an entirely software embodiment or an embodiment containing both hardware and software elements. In a preferred embodiment, the invention is implemented in software, which includes but is not limited to firmware, resident software, microcode, etc.

The system of the present disclosure can take the form of a computer program product accessible from a computer-usable or computer-readable medium providing program code for use by or in connection with a computer or any instruction execution system. For the purposes of this description, a computer-usable or computer readable medium can be any tangible apparatus that can contain or store the program for use by or in connection with the instruction execution system, apparatus, or device. The medium is tangible, and it can be an electronic, magnetic, optical, electromagnetic, infrared, or semiconductor system (or apparatus or device). Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present disclosure has been presented for purposes of illustration and description, and is not intended to be exhaustive or limited to the invention in the form disclosed. Many modifications and variations will be apparent to those of ordinary skill in the art. The embodiment was chosen and described to best explain the principles of the invention, the practical application, and to enable others of ordinary skill in the art to understand the invention for various embodiments with various modifications as are suited to the particular use contemplated.

While the present invention has been described at some length and with some particularity with respect to the several described embodiments, it is not intended that it should be limited to any such particulars or embodiments or any particular embodiment, but it is to be construed so as to provide the broadest possible interpretation of such disclosure in view of the prior art and, therefore, to effectively encompass the intended scope of the invention. Furthermore, the foregoing describes the invention in terms of embodiments foreseen by the inventor for which an enabling description was available, notwithstanding that insubstantial modifications of the invention, not presently foreseen, may nonetheless represent equivalents thereto.

I claim:

1. A computer based method for distributing media comprising:
creating a content bundle;
publishing the content bundle with associated publication rules, the publication rules defining a first physical location;
determining that a first consumer is at the first physical location;
making the content bundle available to the first consumer;
enabling the first consumer to republish the content bundle with associated republication rules, the republication rules defining a second physical location different from the first physical location;
determining that a second consumer is at the second physical location; and
making the content bundle available to the second consumer.

2. The method of claim 1 further comprising publishing to a social media platform a notification that the content bundle has been republished by the first consumer.

3. The method of claim 1 further comprising tracking the downloading of the content bundle by consumers to whom it was made available.

4. The method of claim 3 further comprising ranking the content bundle among a plurality of content bundles based on the number of times it was downloaded.

5. The method of claim 3 further comprising comparing the downloading of identical content bundles with different publication rules defining different physical locations.

6. The method of claim 1 further comprising tracking the republication of the content bundle by consumers to whom it was made available.

7. The method of claim 1 wherein the content bundle comprises digital media files.

8. The method of claim 1 further comprising providing a user interface to the first consumer indicating the first physical location of the content bundle.

9. The method of claim 8 wherein the user interface comprises a map featuring an icon illustrating the first physical location on the map.

10. The method of claim 9 wherein the content bundle further comprises meta-data including at least one classification, and wherein the user interface further comprises a filter based on the classification.

11. The method of claim 1 wherein the first physical location is a physical location of a publisher of the content bundle at the time of publication.

12. The method of claim 1 wherein the republication rules define the second physical location based on the first consumers physical location at the time of republication.

13. A system for distributing media, the system comprising:
an application server in communication with a computerized network;
an administrator interface device in communication with the computerized network;
and a first user interface device in communication with the computerized network;
wherein the application server has a memory for storing and a processor for implementing a software application, and
wherein the application server is in communication with a storage for storing content bundles,
and wherein the software application comprises instructions for:
receiving a content bundle from the administrator interface device including content and publication data, the publication data including first physical location;
storing the content bundle in the storage;
receiving an indication from the first user interface device including a physical location of the first user interface device;
determining if the physical location of the first user interface device matches the first physical location, and if so, authorizing the retrieval or download of the content bundle from the storage.

14. The system of claim 13 wherein the software application further comprises instructions for:
receive a request from the first user interface device to republish the content bundle;
determining a physical location of the first user interface device at the time of the request; and
incorporating republication data into the content bundle, the republication data including a second physical location based on the physical location of the first user interface device at the time of the request.

15. The system of claim 13 further comprising a second user interface device, wherein the software application further comprises instructions for:
Receiving an indication from the second user interface device including a physical location of the first user interface device;
Determining if the physical location of the second user interface device matches the second physical location, and if so, authorizing the retrieval or download of the content bundle from the storage.
